(19) United States
(12) Patent Application Publication
(10) Pub. No.: US 2009/0006066 A1
(43) Pub. Date: Jan. 1, 2009

(54) Method and System for Automatic Selection of Test Cases

(76) Inventors: Michael L. Behm, Cedar Park, TX (US); Steven R. Farago, Austin, TX (US); Brian L. Kozitza, Georgetown, TX (US); John R. Reysa, Austin, TX (US)

Correspondence Address: IBM CORP (YA);C/O YEE & ASSOCIATES PC, P.O. BOX 802333, DALLAS, TX, 75380, US

(21) Appl. No.: 11/769,794

(22) Filed: Jun. 28, 2007

(51) Int. Cl. G06F 17/50

(52) U.S. Cl. 703/15

(57) ABSTRACT

A system for selecting a test case. A test case with a high score is selected. A simulation job is run on a device under test on a plurality of processors using the selected test case. Simulation performance and coverage data is collected for the selected test case and the collected simulation performance and coverage data is stored in a database.

### BACKGROUND OF THE INVENTION

1. Field of the Invention

The present invention relates generally to an improved data processing system. More specifically, the present invention is directed to a computer implemented method, system, and computer usable program code for automatic selection of test cases based on test case scores.

2. Description of the Related Art

Today, computer systems have evolved into extremely sophisticated devices that may be found in many different settings. Typically, computer systems include a combination of hardware components, such as, for example, semiconductors, circuit boards, disk drives, peripheral devices, and the like, and software components, such as, for example, computer programs and applications. The combination of hardware and software components on a particular computer system defines the computing environment.

As advances in semiconductor processing and computer architecture continue to rapidly push the performance of computer hardware higher, more sophisticated computer software programs and applications have evolved to diagnostically test these sophisticated hardware designs. However, current test design testing programs run every available test case to verify hardware designs. Running every available test case to verify a hardware design is a high cost in terms of the amount of resources used. This high cost is especially true with regard to processor overhead.

Therefore, it would be beneficial to have an improved computer implemented method, system, and computer usable program code for automatic selection of test cases based on historical coverage results of the test cases in order to minimize compute hardware costs needed to adequately verify the functionality of a new or modified hardware design.

### SUMMARY OF THE INVENTION

Illustrative embodiments provide a computer implemented method, system, and computer usable program code for selecting a test case. A test case with a high score is automatically selected. A simulation job is run on a device under test on a plurality of processors using the selected test case. Simulation performance and coverage data is collected for the selected test case and the collected simulation performance and coverage data is stored in a database.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating components of a simulation submission system in accordance with an illustrative embodiment; and

FIG. 4 is a flowchart illustrating an exemplary process for automatically selecting a test case in accordance with an illustrative embodiment.

### DETAILED DESCRIPTION OF THE PREFERRED EMBODIMENT

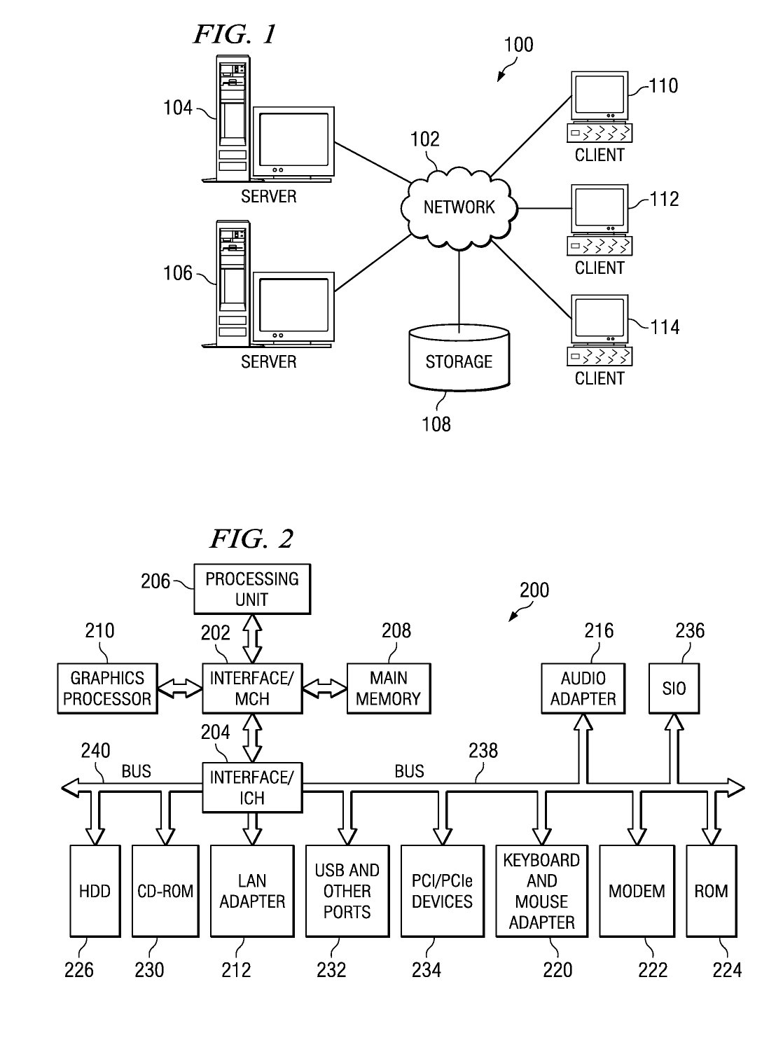

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments provide a computer implemented method, system, and computer usable program code for selecting a test case. A simulation submission system collects simulation performance and coverage data for randomly selected test cases and stores the collected simulation performance and coverage data in a database. Each test case is scored based on the test case's simulation performance and coverage data over time.

The simulation submission system uses an autosubmitter to automatically select a test case with a high score and run a simulation job on a device under test on a plurality of processors, such as a compute farm, using the selected test case. Alternatively, the simulation job on the device under test may be run on only one processor using the selected test case. The device under test is a software model of a new or modified hardware design. The simulation submission system runs the simulation job to see if the new or modified hardware design is logically correct.

The simulation submission system uses a data collection infrastructure to collect simulation performance and coverage data for the selected test case and stores the collected simulation performance and coverage data in a database. In addition, the simulation submission system determines if it is time to calculate test case scores. In response to determining that it is time to calculate test case scores, the simulation submission system runs a test case score calculator. The test case score calculator queries the database for the stored simulation performance and coverage data and calculates the test case scores using the stored simulation performance and coverage data.

Illustrative embodiments increase the efficiency of a compute hardware simulation farm by running only those test cases that are most likely to hit unobserved coverage events. Illustrative embodiments are most useful in the following two situations. First, when a new or modified hardware model is released, illustrative embodiments may help drive coverage to levels observed on previous models as quickly as possible. Second, during periods of rapid model development, illustrative embodiments may maintain coverage levels within a sliding window of time to check new versions of a machine's design. As an example, an illustrative embodiment is used to maintain coverage levels over a one month period of time for a new version of a hardware design. In that one month period of time, the illustrative embodiment maintained 100 coverage events for that new design. However, as the machine's design changes to a newer version, the illustrative embodiment should maintain the 100 coverage events for the newer version of the machine within the sliding window of time.

Illustrative embodiments include four main components. The four main components are the data collection infrastructure, the database, the test case score calculator, and the autosubmitter. The data collection infrastructure component collects simulation performance and coverage statistics for every test case run in a simulation job. The database component tracks these performance and coverage statistics on a test case granularity level.

The test case score calculator component assigns a score to every test case based on a set of currently unhit coverage events and previous coverage performance for each test case. The test case score calculator is periodically run to maintain an up-to-date set of runnable test cases. The autosubmitter component runs test cases, for example, once per day, in the compute farm based on the score assigned by the test case score calculator.

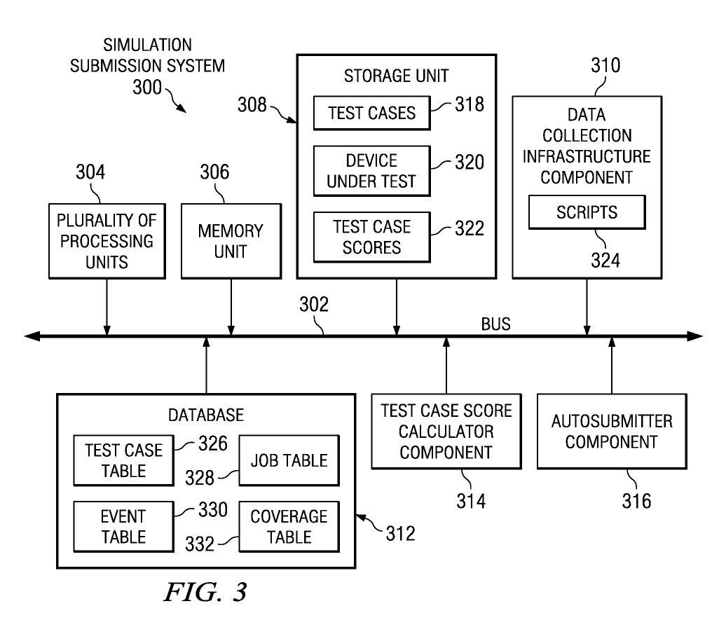

With reference now to FIG. 3, a block diagram illustrating components of a simulation submission system is depicted in accordance with an illustrative embodiment. Simulation submission system 300 may, for example, be implemented in network data processing system 100 in FIG. 1. Simulation submission system 300 is a plurality of hardware and software components coupled together for controlling the automatic selection of test cases used to verify that a new computer hardware design is logically correct.

It should be noted that simulation submission system 300 is only shown for exemplary purposes and is not meant as an architectural limitation to illustrative embodiments. In other words, simulation submission system 300 may include more or fewer components as necessary to perform processes of illustrative embodiments.

In the depicted example, simulation submission system 300 includes bus 302, plurality of processing units 304, memory unit 306, storage unit 308, data collection infrastructure component 310, database 312, test case score calculator component 314, and autosubmitter component 316. Bus 302 may be implemented using any type of communication fabric or architecture that provides for a transfer of data between the different components in simulation submission system 300. In addition, bus 302 may include one or more buses.

Plurality of processing units 304 provide the data processing capabilities for simulation submission system 300. Plurality of processing units 304 may, for example, represent a compute farm, such as server 106 and clients 110, 112, and 114 in FIG. 1. Simulation submission system 300 utilizes plurality of processing units 304 to test a software model of a hardware design.

Storage unit 308 is a non-volatile storage device that may, for example, be configured as read only memory (ROM) and/or flash ROM to provide the non-volatile memory for storing applications and/or generated data. Storage unit 308 also stores instructions or computer usable program code for the applications and illustrative embodiments. The instructions are loaded into memory unit 306 for execution by plurality of processing units 304. Plurality of processing units 304 perform processes of illustrative embodiments by executing the computer usable program code that is loaded into memory unit 306.

Storage unit 308 contains test cases 318, device under test 320, and test case scores 322. Test cases 318 are sets of test data and test programs or scripts, along with expected test results. Simulation submission system 300 uses test cases 318 to test device under test 320.

Test cases 318 validate requirements of device under test 320 and generate data regarding results of those tests. Test cases 318 test coverage events in a new or modified design or architecture during a simulation job. Coverage events are the desired states within the new or modified design or architecture.

Device under test 320 is the software model of the new or modified hardware design. Further, device under test 320 defines the coverage events that need to be hit by test cases 318. Also, it should be noted that device under test 320 may represent a plurality of devices under test.

Further it should be noted that for efficiency purposes, simulation submission system 300 may run more than one test case at a time during a simulation job on device under test 320. However, even though simulation submission system 300 may run more than one test case at a time during a simulation job, simulation submission system 300 stores data for each test case individually. Simulation submission system 300 may store this data in database 312.

Test case scores 322 are assigned scores for each test case in test cases 318. Test case score calculator component 314 calculates test case scores 322. Test case score calculator component 314 calculates test case scores 322 from data obtained by data collection infrastructure component 310. Test case scores 322 may be calculated and updated on a predetermined basis, such as, for example, hourly, daily, or weekly. It should be noted that even though test case scores 322 are stored in storage unit 308 in the depicted example, test case scores 322 may be stored in database 312 instead of, or in addition to, storage unit 308.

Data collection infrastructure component 310 collects simulation performance and coverage data for each test case run from test cases 318. Data collection infrastructure component 310 may be implemented entirely as software, hardware, or as a combination of software and hardware components. Data collection infrastructure component 310 includes scripts 324. Scripts 324 are a series of scripts, such as, for example, perl scripts, or other software programs that run as a simulation postprocessor. A simulation postprocessor is a script that looks at the result of a test case run and stores the test case result data in a database, such as database 312.

Data collection infrastructure component 310 uses scripts 324 to obtain the simulation performance and coverage data. Scripts 324 obtain this data by parsing various output files to collect identifying information, such as project identifier, category information (e.g., menu and list), and test case identifier; job information, such as elapsed simulation time and elapsed generation time; simulation runtime statistics, such as cycles simulated and hardware model; and a count of every relevant coverage event hit by a test case during the course of the simulation job.

At the end of every simulation job, data collection infrastructure component 310 manipulates this collected simulation performance and coverage data for test cases 318 into a format suitable for storage in database 312. Database 312 may, for example, be storage 108 in FIG. 1. In addition, database 312 may be a relational database.

Specifically, data collection infrastructure component 310 stores the data that is common to every execution of the simulation job's test case, such as, for example, categorization data like project, menu, and list, in test case table 326. In job table 328, data collection infrastructure component 310 stores job specific data, such as simulation runtime statistics, a job timestamp, a simulation job identifier, and a reference to the associated entry in test case table 326. In event table 330, data collection infrastructure component 310 stores all coverage event names for the design, as well as any other event identifying information. Finally, in coverage table 332, data collection infrastructure component 310 stores a list of pairs of event table 330 references and counts, which indicate how often a particular simulation job hit each coverage event.

Test case score calculator component 314 takes a range of time, such as, for example, one month, as input. Then, test case score calculator component 314 queries database 312 to find all coverage events not yet hit within that specified time range. After compiling a missed coverage event list, test case score calculator component 314 makes the following calculations from the stored simulation performance and coverage data for test cases 318 in database 312. For every coverage event (E) in the missed coverage event list and every test case (T), test case score calculator component 314 calculates:

1) P(E|T)=the number of jobs where test case T hit event E/# jobs run with test case T;

2) P(E)=(1/# of test cases)*Sum(P (E|Tᵢ), over all runnable test cases; and

3) Efficiency(E|T)=P(E|T)/Average Runtime(T).

Given these calculated values, test case score calculator component 314 selects a subset, such as, for example, subset Tᵣ, from all runnable tests with the property that for every event Eᵢ in the list of missed coverage events, P(Eᵢ|Tⱼ)>0 for some Tⱼ in subset Tᵣ. Stated differently, test case score calculator component 314 selects a set of tests so that every missed coverage event has a nonzero chance of being hit. Subsequently, test case score calculator component 314 passes every test in Tⱼ to autosubmitter component 316.

Autosubmitter component 316 automatically selects test cases from test cases 318 based on test case scores 322. It should be noted that autosubmitter component 316 may represent one or more autosubmitters and may be implemented entirely as software, hardware, or a combination of software and hardware components.

Autosubmitter component 316 selects test cases that are likely to hit coverage events not previously hit during a simulation job. Autosubmitter component 316 tries to make sure that every coverage event for device under test 320 is hit, for example, at least once per month.

The test case selection algorithm may be any type of set coverage heuristic. Possible alternative selection algorithms may include:

1) greedy based on conditional coverage event/test case probabilities with a randomly ordered missed events list;

2) greedy based on conditional coverage event/test case probabilities with an ordered missed events list sorted by increasing likelihood of hitting a coverage event given any test case (i.e., P(E)); and

3) greedy based on Efficiency scores with missed coverage events lists ordered as in number two above.

Greedy means that autosubmitter component 316 selects the very best test script, then the next best test script, and so on, until the goal is achieved according to the selection algorithm used.

Autosubmitter component 316 utilizes test case scores 322 as input to automatically select the test case with the highest probability score or a high probability score. Autosubmitter component 316 sums all of the test case scores and then assigns a probability to each test case. The probability is proportional to each test case's assigned score relative to the sum of all test case scores. Autosubmitter component 316 automatically selects and submits a test case based on this probability distribution, along with device under test 320, to plurality of processing units 304 (i.e., the compute farm) for execution. Thus, simulation submission system 300 is able to verify that a new computer hardware design or architecture is logically correct without running all test cases during a simulation job, thereby saving valuable compute farm resources.

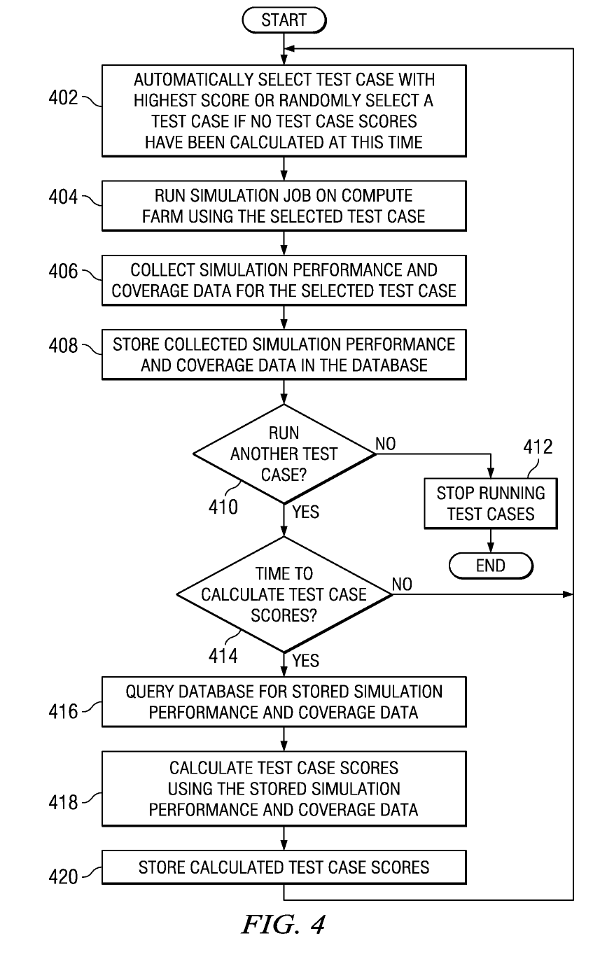

With reference now to FIG. 4, a flowchart illustrating an exemplary process for automatically selecting a test case is shown in accordance with an illustrative embodiment. The process shown in FIG. 4 may be implemented in a simulation submission system, such as, for example, simulation submission system 300 in FIG. 3.

The process begins when the simulation submission system uses an autosubmitter, such as, for example, autosubmitter component 316 in FIG. 3, to select a test case, such as, for example, one of test cases 318 in FIG. 3, with a high score (step 402). The autosubmitter accesses test case scores, such as, for example, test case scores 322 in FIG. 3, stored in a storage unit, such as, for example, storage unit 308 in FIG. 3, in order to determine the test case with the highest score. However, it should be noted that the autosubmitter may instead access the test case scores in a database, such as, for example, database 312 in FIG. 3.

The autosubmitter may also randomly select a test case if no test case scores have been calculated and assigned at this time. After selecting a test case in step 402, the autosubmitter runs a simulation job on a compute farm, such as, for example, plurality of processing units 304 in FIG. 3, using the selected test case (step 404). The compute farm performs the simulation job on a device under test, such as, for example, device under test 320 in FIG. 3. Then, the simulation submission system utilizes a data collection infrastructure, such as, for example, data collection infrastructure component 310 in FIG. 3, to collect simulation performance and coverage data for the selected test case (step 406). The data collection infrastructure employs a set of scripts, such as, for example, scripts 324 in FIG. 3, to perform this data collection task.

Subsequent to collecting the simulation performance and coverage data in step 406, the data collection infrastructure stores the collected simulation performance and coverage data in the database (step 408). It should be noted that the database may store the collected simulation and coverage data in one or more tables for later reference. Afterward, the simulation submission system makes a determination as to whether to run another test case (step 410).

If the simulation submission system determines not to run another test case, no output of step 410, then the simulation submission system stops running test cases (step 412). Thereafter, the process terminates. If the simulation submission system determines to run another test case, yes output of step 410, then the simulation submission system makes a determination as to whether it is time to calculate test case scores (step 414). The determination to calculate test case scores may, for example, be on a predetermined time interval basis or on user demand. The predetermined time interval basis may, for example, be once per hour, day, or week. The user may, for example, be a system administrator.

If it is not time to calculate test case scores, no output of step 414, then the process returns to step 402 where the autosubmitter selects a test case. If it is time to calculate test case scores, yes output of step 414, then the simulation submission system utilizes a test case score calculator, such as, for example, test case score calculator component 314 in FIG. 3, to query the database for the stored simulation performance and coverage data for one or more test cases (step 416). Then, the test case score calculator calculates test case scores for the one or more test cases using the stored simulation performance and coverage data (step 418). Subsequently, the test case score calculator stores the calculated test case scores in the storage unit (step 420). Alternatively, the test case score calculator may store the calculated test case scores in the database. Thereafter, the process returns to step 402 where the autosubmitter automatically selects the test case with the highest score.

Thus, illustrative embodiments provide a computer implemented method, system, and computer usable program code for automatic test case selection to perform a simulation on a device under test. The invention may take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer-readable medium may be any tangible apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a ROM, a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, et cetera) may be coupled to the system either directly or through intervening I/O controllers.

Network adapters also may be coupled to the system to enable the data processing system to become coupled to other data processing systems, remote printers, or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for selecting a test case, the computer implemented method comprising:
selecting a test case with a high score to form a selected test case;
running a simulation job on a device under test on a plurality of processors using the selected test case;
collecting simulation performance and coverage data for the selected test case to form collected simulation performance and coverage data; and
storing the collected simulation performance and coverage data in a database to form stored simulation performance and coverage data.

2. The computer implemented method of claim 1, further comprising:
determining if it is time to calculate test case scores;
responsive to determining that it is time to calculate the test case scores, querying the database for the stored simulation performance and coverage data;
calculating the test case scores using the stored simulation performance and coverage data to form calculated test case scores; and
storing the calculated test case scores.

3. The computer implemented method of claim 1, wherein the simulation job is used to verify that a new or modified hardware design is logically correct.

4. The computer implemented method of claim 1, wherein the plurality of processors comprise a compute farm.

5. The computer implemented method of claim 2, wherein the time to calculate the test case scores is a predetermined time interval.

6. The computer implemented method of claim 1, wherein a data collection infrastructure component collects the simulation performance and coverage data for the selected test case.

7. The computer implemented method of claim 6, wherein the data collection infrastructure component includes a set of scripts, and wherein the set of scripts are a set of perl scripts.

8. The computer implemented method of claim 1, wherein the database stores the simulation performance and coverage data for the selected test case in four tables, and wherein the four tables are a test case table, a job table, an event table, and a coverage table.

9. The computer implemented method of claim 8, wherein the test case table stores data that is common to every execution of the selected test case during the simulation job, and wherein the job table stores job specific data, and wherein the event table stores all coverage event names for a new or modified hardware design, and wherein the coverage table stores a list of pairs of event table references and counts.

10. The computer implemented method of claim 1, wherein the device under test is a software model of a new or modified hardware design.

11. The computer implemented method of claim 1, wherein the device under test defines coverage events that need to be hit by the selected test case.

12. The computer implemented method of claim 1, wherein an autosubmitter selects the test case with the high score and runs the simulation job on the device under test on the plurality of processors using the selected test case.

13. The computer implemented method of claim 2, wherein a test case score calculator queries the database to find all coverage events not yet hit within a specified period of time, and wherein the specified period of time is one month.

14. The computer implemented method of claim 1, wherein the selected test case is one of a plurality of test cases.

15. The computer implemented method of claim 1, wherein the high score is a high probability score, and wherein the high probability score is proportional to an assigned score for the selected test case relative to a sum of all test case scores.

16. The computer implemented method of claim 12, wherein the autosubmitter runs only those test cases that are most likely to hit unobserved coverage events.

17. The computer implemented method of claim 14, wherein the plurality of test cases test coverage events in a new or modified hardware design during the simulation job, and wherein the coverage events are desired states within the new or modified hardware design.

18. A data processing system for selecting a test case, comprising:
a bus system;
a storage device connected to the bus system, wherein the storage device includes a set of instructions; and
a processing unit connected to the bus system, wherein the processing unit executes the set of instructions to select a test case with a high score to form a selected test case, run a simulation job on a device under test on a plurality of processors using the selected test case, collect simulation performance and coverage data for the selected test case to form collected simulation performance and coverage data, and store the collected simulation performance and coverage data in a database to form stored simulation performance and coverage data.

19. A computer program product for selecting a test case, the computer program product comprising:
a computer usable medium having computer usable program code embodied therein, the computer usable medium comprising:
computer usable program code configured to select a test case with a high score to form a selected test case;
computer usable program code configured to run a simulation job on a device under test on a plurality of processors using the selected test case;
computer usable program code configured to collect simulation performance and coverage data for the selected test case to form collected simulation performance and coverage data; and
computer usable program code configured to store the collected simulation performance and coverage data in a database to form stored simulation performance and coverage data.

20. The computer program product of claim 19, further comprising:
computer usable program code configured to determine if it is time to calculate test case scores;
computer usable program code configured to query the database for the stored simulation performance and coverage data in response to determining that it is time to calculate the test case scores;
computer usable program code configured to calculate the test case scores using the stored simulation performance and coverage data to form calculated test case scores; and
computer usable program code configured to store the calculated test case scores.
